(19) United States
(12) Patent Application Publication
(10) Pub. No.: US 2009/0312796 A1
(43) Pub. Date: Dec. 17, 2009

(54) PACIFIER

(75) Inventors: Eckhard Itzek, Gyhum-Nartum (DE); Guenter Marr, Rosengarten (DE)

Correspondence Address: VIDAS, ARRETT & STEINKRAUS, P.A., SUITE 400, 6640 SHADY OAK ROAD, EDEN PRAIRIE, MN, 55344, US

(73) Assignee: MAPA GMBH, Zeven (DE)

(21) Appl. No.: 12/300,733

(22) PCT Filed: Jan. 10, 2007
(86) PCT No.: PCT/EP2007/000133

§ 371 Date: Mar. 4, 2009

(30) Foreign Application Priority Data
May 16, 2006 (DE) 10 2006 022 669.0

(51) Int. Cl. A61J 17/00

(52) U.S. Cl. 606/236

(57) ABSTRACT

A pacifier with a mouth shield made of relatively firm material, a nipple protruding from the inside of the mouth shield and made of relatively soft material, and a security thread connected to the mouth shield, which consists of the relatively firm material, is connected to the nipple and extends in the longitudinal direction thereof, characterized in that a first section of the security thread runs at a distance from those areas of the nipple which are intersected by the imaginary sagittal midplane of the nipple.

The present invention is related to a pacifier with a mouth shield, a nipple fastened thereon and a security thread connected to the mouth shield and the nipple.

It is known to protect the nipple against separation due to strong sucking or biting off by a security thread, which is purposefully made of a firmer material than the relatively soft nipple.

Such a pacifier is known from the German patent document DE 4229 224 C2. In the known pacifier, mouth shield and nipple consist of a thermoplastic elastomer and are cross linked with each other. A security strip is made of the same material as the mouth shield, connected to the mouth shield on both ends and guided circumferentially around the nipple in the longitudinal direction thereof.

Starting from this, it is the objective of the present invention to provide a pacifier which permits safe use.

This objective is resolved by the features of the claim 1, of the claim 20 and by the method for producing a pacifier according to claim 24. Advantageous embodiments of the present invention are indicated in the subclaims.

According to claim 1, the pacifier of the present invention has a mouth shield made of a relatively firm material, a nipple protruding from the inside of the mouth shield and made of a relatively soft material, and a security thread connected to the mouth shield, which consists of the relatively firm material, is connected to the nipple and extends in the longitudinal direction thereof. A first section of the security thread runs at a distance from those areas of the nipple which are intersected by the imaginary sagittal midplane of the nipple.

Terms designating a direction like sagittal, transversal and right or left are related now and in the following to the head of a user, which has the pacifier of the present invention in the mouth.

The present invention is based on the finding that the protection against biting off of the nipple, which is obtainable by a security thread made of a firmer material, should be improved still further. In particular, the arrangement of the security thread with respect to the teeth plays a particular role. In the known arrangement of the security thread along an imaginary sagittal midplane of the nipple, both end sections of the security thread connected to the mouth shield are located in a position which is particularly exposed with respect to the teeth or tooth rows, respectively, of a suckling or infant. Through this, a cut-through of one or both sections of the security thread connected to the mouth shield can take place upon strong biting.

In the invention, the danger of biting off is prevented in that a section of the security thread has a distance from the particularly exposed regions of the nipple. Due to the anatomical arrangement of the teeth, these particularly exposed regions are situated in the middle of the nipple, more accurately in those regions of the nipple which are intersected by the imaginary sagittal midplane of the nipple, because the incisors of a user first hit the nipple in these areas in particular. This holds as well for the two lower incisors, which break through in a suckling normally at first (sixth to seventh month), as to the two upper incisors (eight to tenth month). The distance to these areas which is to be maintained according to the present invention can be given in an arbitrary direction, in a hollow nipple, the security thread can be guided along the longitudinal axis of the nipple, for instance. Through this, it is protected at least by the walls of the nipple located above and below the security thread. In the case that these walls are damaged due to use of the pacifier, this can normally be recognized by an attending person and the pacifier can be replaced before the security thread can be cut through by further biting movements.

According to a particularly preferred embodiment, the first section of the security thread runs at a distance from the sagittal midplane of the nipple. Thus, the security thread is in a distance from the midplane and the longitudinal axis of the nipple.

In a further embodiment of the present invention, the security thread is connected to the mouth shield on both ends and a second section of the security thread is spaced apart in the right-left direction with respect to the first section. Through this, it is achieved that two sections of the security thread make the connection between the nipple and the mouth shield, and are located at different positions in the right-left direction. In order to be able to separate the nipple from the mouth shield, sections of the security thread at different positions with respect to the tooth rows of the user have therefore to be bitten through. The probability that both sections of the security thread are bitten through at the same time is significantly reduced through this.

In a preferred embodiment of the present invention, the first and the second section of the security thread are arranged inside the nipple such that their distance in the right-left direction is maximum. Through the particularly great distance between the two sections of the security thread, the danger of simultaneous cut-through is reduced further.

According to a preferred embodiment of the present invention, the first and the second section of the security thread are arranged symmetric to the sagittal midplane of the nipple. A symmetric arrangement provides advantages in the manufacture and guarantees a uniform deformability of the nipple.

In a further embodiment of the present invention, the first and/or the second section of the security thread are arranged close to the mouth shield, so that they are situated in the region of the tooth rows of a user. In this case, the sections of the security thread which are spaced apart according to the present invention are purposefully arranged in the area of the tooth rows of a user, i.e. at a preset position with respect to the longitudinal direction of the nipple.

In a further embodiment of the present invention, the security thread runs approximately in a transversal plane. This favors the flexibility of the nipple. In an orthodontic form of the nipple, the security thread runs in the area of the greatest cross sectional width, and thus only approximately in a transversal plane. Even through this, a maximum flexibility is maintained.

According to a further embodiment of the present invention, the security thread is deflected at the end of the nipple which is turned away from the mouth shield. Thus, the security thread forms a loop which is fastened on the mouth shield at both ends thereof.

In a further, preferred embodiment of the present invention, the nipple is hollow. Through this, the elastic properties of the nipple are improved.

Through a further on provided opening of the nipple at the side facing the mouth shield, the air which is in the nipple can escape when the nipple is pressed together.

According to a further embodiment of the present invention, the nipple is connected to the mouth shield via an edge section projecting on the perimeter side. Through this design of the nipple, a secure connection with the mouth shield is favored. Further, the nipple is particularly soft in the area of the connection between nipple and mouth shield, which increases the usage convenience.

In a further, preferred embodiment of the present invention, the security thread is connected to the nipple in the region of the tooth rows of a user and/or in the region of the tip of the nipple. In the case that the nipple is hollow and connected to the security thread in the region of the tooth rows, the security thread runs along the wall of the nipple in the area of the tooth rows of a user. Through the connection of the security thread with the nipple in an area extending across a certain length of the security thread, the nipple retains its form better, even in a damage of its wall. On the other hand, a connection predominantly in the area of the tip of the nipple favors the flexibility of the nipple.

Further preferred is an embedding of the security thread into a wall of the nipple. A particularly secure connection is achieved through this.

According to a further embodiment, the nipple overlaps the security thread at the side facing a user. Through this, the outer side of the nipple is completely formed by the relatively soft material of the nipple. The usage convenience is increased through the uniformly soft surface.

According to a further, preferred embodiment of the present invention, the relatively firm material is a thermoplastic plastic material. Also preferably, the relatively firm material is a thermoplastic elastomer. Both materials are suited for the preferably used injection molding method for the manufacture of the mouth shield and the security thread. When using a thermoplastic elastomer, the composition of the material is selected such that a material is generated which is relatively firm at ambient temperature.

According to a further, preferred embodiment, the relatively firm material is a thermoplastic elastomer. In principle, even other elastic materials are suitable for the nipple, for instance natural rubber or silicone. Thermoplastic elastomers are multiphase materials, which have rubber-like elastically deformable molecular areas into which regions of fusible amorphous thermoplasts are built in. For this reason, they can be deformed thermoplastically, and at the same time they feature the desired elastic properties. In particular, they are also accessible by the injection molding method. According to the circumstances, this means a significant facilitation of the manufacture.

In a further, preferred embodiment of the present invention, the nipple is cross linked with the security thread and/or the mouth shield. Through this, a particularly intrinsic connection of the two different materials is achieved. In principle, the connection may be obtained even in another way, like by glueing for instance. However, cross linking is a particularly simple and secure method of connection. According to the selection of the material, it may be dealt with a chemical cross linking or a so-called physical cross linking. In the latter, the molecular chains are not chemically cross linked with each other, but only entangled with each other.

According to a further preferred embodiment of the present invention, the relatively soft material contains the same base polymer as the relatively firm material. From this result advantages with respect to the connectability and crosslinkability of the two materials.

According to claim 20, the pacifier of the present invention has a mouth shield made of relatively firm material, a nipple protruding from the inner side of the mouth shield and made of relatively soft material, and a handle arranged on the mouth shield. The handle has two bows made of the relatively firm material, whose ends are connected to the mouth shield. In principle, this pacifier of the present invention can be combined with each of the features mentioned above.

Both bows are connected to the mouth shield at their ends and consist of the same, relatively firm material as the mouth shield. Therefore, they can be injection molded in one procedural step with the mouth shield. Through this, a particularly simple method to manufacture a pacifier with a handle is at hand.

In a preferred embodiment, the bows are pivoted around an axis close to their connection points with the mouth shield, and are connected with each other in their central sections. That means, the bows formed on the mouth shield are at first in a first position in their manufacture and are formed such that they can be swiveled around an axis close to their connection points. By swiveling, the bows are set into a second position, in which the central sections of the two bows touch each other. In this position, the two central sections of the bows are connected with each other. The first position of the bows can be selected such that the work piece can be demolded in a simple way. Thus, a handle is created which supports itself on the mouth shield on the four connection points of the two bows.

In a preferred embodiment of the present invention, the central sections of the two bows are welded together with each other. In this, it is dealt witch a particularly stable and simple connection. Alternatively, even a raster connection may be provided.

In a further, preferred embodiment of the present invention, the central sections of the bows are provided with ribs at the sides facing each other. The ribs can facilitate a matching linkage of the two bows and they can facilitate the connecting process, a welding in particular. In an ultrasound welding, even corresponding direction transmitters for the energy can be provided.

In the method of the present invention for manufacturing a pacifier according to claim 24, the two bows are injection molded in one piece with the mouth shield in a first, spaced apart from each other position and subsequently combined and welded together with each other by swiveling the bows around an axis close to their connection points with the mouth shield.

In the following, the present invention is explained in more detail by means of two examples of its realization depicted in figures.

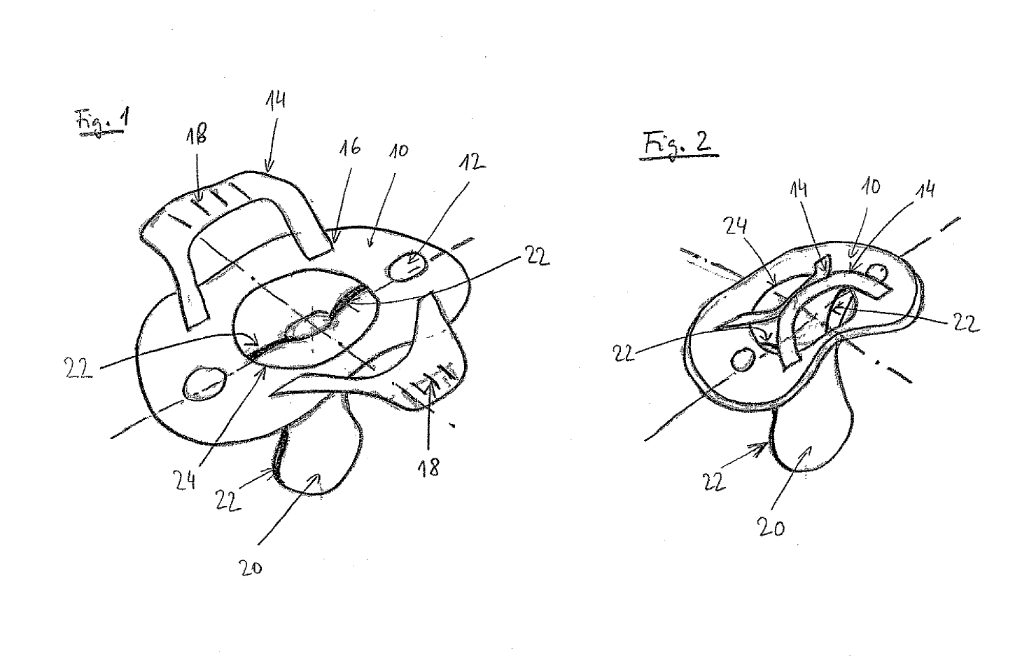

FIG. 1 shows a pacifier with handle bows swiveled away from each other, in a perspective view from the side turned away from the user,

FIG. 2 shows the pacifier of FIG. 1 with connected handle bows in the view of FIG. 1,

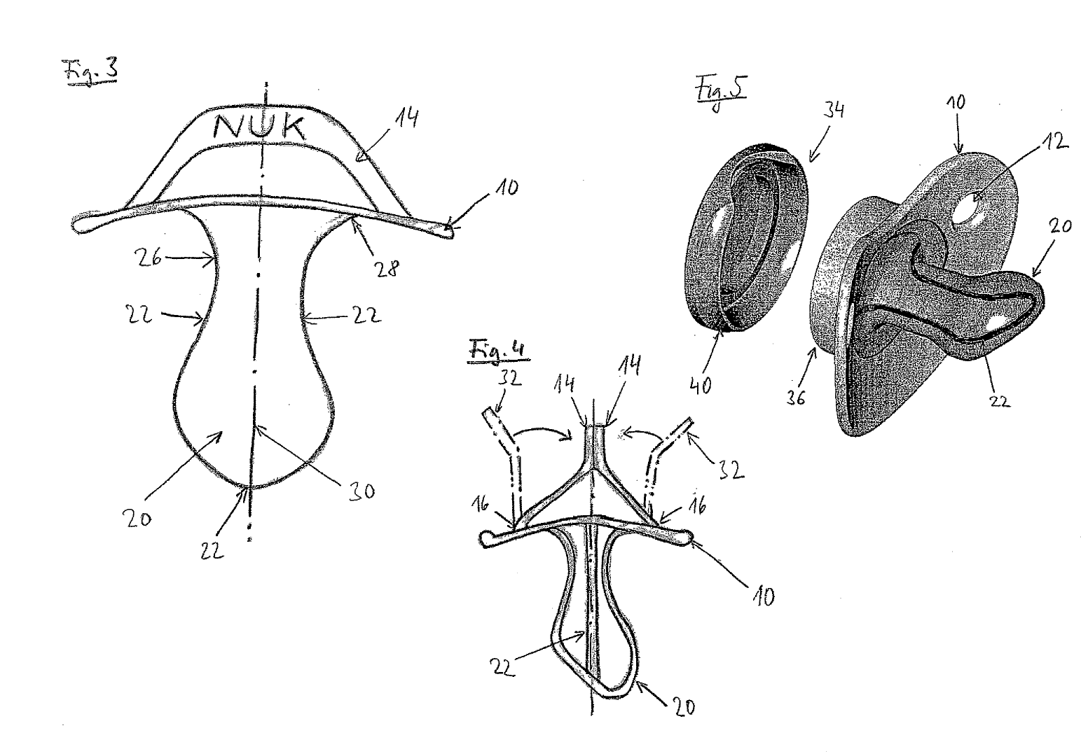

FIG. 3 shows the pacifier of FIG. 1 in a cross section in a transversal plane,

FIG. 4 shows the pacifier of FIG. 1 in a partial cross section in a sagittal plane,

FIG. 5 shows a perspective view of a further realization example of a pacifier of the present invention.

The pacifier depicted in FIG. 1 consists of a mouth shield 10, two bows 14 forming a handle and a nipple 20.

The mouth shield 10 is essentially concave and matched to the outer anatomy of the mouth. The outer contour of the mouth shield 10 is essentially kidney shaped with a rounding having a great radius on the upper edge as a free space for the nose onset. Two emergency breathing holes 12 are arranged on the right and left side of the mouth shield 10. In the middle of the mouth shield 10, there is an approximately elliptic opening 24, on whose edge area the nipple 20 is connected to the mouth shield 10.

The two bows 14 are each one connected to the outer side of the mouth shield 10 on their two ends. For so long as the two bows are not connected with each other yet, each bow 14 is pivotal around an axis which runs approximately through the two connection points 16 with the mouth shield 10. In a middle section of each bow there are ribs 18, in whose area both bows 14 arrive in bearing against each other after swiveling the two bows towards each other, and are then welded together. The mouth shield 10 and the two bows 14 consist of a relatively firm material, in the depicted example of a thermoplastic plastic material like polypropylene (PP) for instance.

The security thread 22 is also made of a relatively firm material, whose ends pass into the edge of the elliptic opening 24 of the mouth shield 10 at their right and left sides. In the manufacture, the security thread 22 is injection molded jointly with the mouth shield and the two bows 14.

The nipple 20 consists of a relatively soft thermoplastic elastomer. The end of the nipple 20 shown at the bottom side in the drawing is in the oral cavity of the user during use, the opposite end enlarges in the form of a funnel with elliptic cross section up to the diameter of the opening 24. The nipple is hollow in its inside and has an opening at the side facing the mouth shield, through which air can escape from the cavity. On the not visible bottom side of the mouth shield 10, the enlarged end of the nipple 20 is connected to the mouth shield 10.

The security thread 22 runs approximately in a transversal plane along the wall of the hollow nipple 20. Like all the other components of the pacifier, even the security thread 22 is arranged symmetric to the sagittal midplane of the pacifier. In this, the sections of the security thread 22 arranged at the right and at the left of the sagittal midplane are always in the greatest possible distance, for maximum flexibility and softness of the nipple.

In FIG. 1, the two bows 14 are in a position where they are spaced apart from each other, in which they can be easily demolded after the injection molding.

In the depiction in FIG. 2, the two bows 14 are swiveled compared with their first position, so that they meet each other in their central sections. In this area, they are welded together. Through this, one single handle arises, which is securely fastened on the mouth shield 10 by the four ends of the two bows.

In the cross sectional depiction of FIG. 3, one recognizes the rounded form of the nipple 20 and the security thread 22, which is embedded into the wall of the nipple 20 and runs in the depicted transversal section plane in its whole length. At its two ends, the security thread 22 passes seamlessly into the mouth shield 10. The nipple 20, funnel-like enlarged in the direction towards the mouth shield 10, has an edge section projecting on the perimeter side at 28, which is connected to the mouth shield 10. The arrangement of the security thread 22, completely symmetric with respect to the sagittal midplane 30, can be recognized easily. Even in the area of the tooth rows, at 26, the sections of the security thread 22 arranged at both sides of the sagittal midplane 30 feature a maximum distance.

FIG. 4 shows the pacifier partly in the cross section along the sagittal midplane. The design of the nipple 20, executed according to anatomical viewpoints, can be recognized easily. The security thread 22 runs in a distance to the sectional plane of the depiction, however, in order to illustrate its course in a transversal plane, it has been incorporated into the drawing anyhow. The two bows 14 are depicted in their combined position. In addition, the two bows 14 are depicted in dashed lines in a first position 32, in order to illustrate the manufacturing process. The position 32 corresponds to the position of the bows 14 after the injection molding and facilitates the demolding of the work piece. Thereafter, the bows 14 are swiveled about their connection points 16 with the mouth shield 10.

Finally, FIG. 5 shows a further example of the realization of the present invention in a perspective view. The depicted realization example differs from those of FIG. 1 to 4 particularly in that a so-called dome 36 is formed on the side of the mouth shield 10 turned away from the user. This dome is closed by a cover-up cap 34 on the side turned away from the user. The cap has an approximately round form and features a circulating throat 40, which is particularly handily.

At option, even a cover-up cap 34 with recesses for fastening a not shown, movable ring can also be used.

1. A pacifier with a mouth shield (10) made of a relatively firm material, a hollow nipple (20) protruding from the inside of the mouth shield (10) and made of a relatively soft material, and a security thread (22) connected to the mouth shield, which consists of the relatively firm material, is connected to the nipple (20) and extends in the longitudinal direction thereof, characterized in that a first section of the security thread (22) runs at a distance from those areas of the nipple (20) which are intersected by the imaginary sagittal midplane of the nipple (20).

2. A pacifier according to claim 1, characterized in that the first section of the security thread (22) runs at a distance from the sagittal midplane of the nipple (20).

3. A pacifier according to claim 1, characterized in that the security thread (22) is connected to the mouth shield (10) on both ends and a second section of the security thread (22) is spaced apart in the right-left direction with respect to the first section.

4. A pacifier according to claim 1, characterized in that first and second section of the security thread (22) are arranged inside the nipple (20), such that their distance in the right-left direction is maximum.

5. A pacifier according to claim 1, characterized in that the first and the second section of the security thread (22) are arranged symmetric to the sagittal midplane of the pacifier.

6. A pacifier according to claim 1, characterized in that the first and/or the second section of the security thread (22) are arranged close to the mouth shield (10), so that they are situated in the area (26) of the tooth rows of a user.

7. A pacifier according to claim 1, characterized in that the security thread (22) runs approximately in a transversal plane.

8. A pacifier according to claim 1, characterized in that the security thread (22) is deflected at the end of the nipple (20) which is turned away from the mouth shield (10).

9. A pacifier according to claim 1, characterized in that the nipple (20) has an opening at the side facing the mouth shield (10).

10. A pacifier according to claim 1, characterized in that the nipple (20) is connected to the mouth shield (10) via an edge section projecting on the perimeter side.

11. A pacifier according to claim 1, characterized in that the security thread (22) is connected to the nipple (20) in the area (26) of the tooth rows of a user and/or in the area of the tip of the nipple (20).

12. A pacifier according to claim 1, characterized in that the security thread (22) is embedded into a wall of the nipple (20).

13. A pacifier according to claim 1, characterized in that the nipple (20) overlaps the security thread (22) at the side facing a user.

14. A pacifier according to claim 1, characterized in that the relatively firm material is a thermoplastic plastic material.

15. A pacifier according to claim 1, characterized in that the relatively firm material is a thermoplastic elastomer.

16. A pacifier according to claim 1, characterized in that the relatively soft material is a thermoplastic elastomer.

17. A pacifier according to claim 15, characterized in that the nipple (20) is cross linked with the security thread (22) and/or the mouth shield (10).

18. A pacifier according to claim 15, characterized in that the relatively soft material contains the same base polymer as the relatively firm material.

19. A pacifier, in particular according to claim 1, with a mouth shield (10) made of a relatively firm material, a nipple protruding from the inner side of the mouth shield (10) and made of a relatively soft material, and a handle arranged on the mouth shield (10), characterized in that the handle has two bows (14) made of the relatively firm material, whose ends are connected to the mouth shield (10).

20. A pacifier according to claim 19, characterized in that the bows (14) are pivoted around an axis close to their connection points (16) with the mouth shield (10), and are connected with each other in their central sections.

21. A pacifier according to claim 19, characterized in that the bows (14) are welded together in their central sections.

22. A pacifier according to claim 19, characterized in that the central sections of the bows (14) are provided with ribs (18) at their sides facing each other.

23. A method for producing the pacifier according to claim 19, characterized in that the two bows (14) are injection molded in one piece with the mouth shield (10) in a first, spaced apart from each other position, and subsequently combined and welded together with each other by swiveling the bows (14) around an axis close to their connection points (16) with the mouth shield (10).
